(19) United States
(12) Patent Application Publication
(10) Pub. No.: US 2022/0258903 A1
(43) Pub. Date: Aug. 18, 2022

(54) BEVERAGE BOTTLING DEVICE FOR THE HANDLING OF BEVERAGE BOTTLES AND SIMILAR CONTAINERS IN A BEVERAGE BOTTLING PLANT

(71) Applicants: Patrick NIEHOFF, Bochum (DE); Lutz DECKERT, Haltern am See (DE); Gyula VARHANIOVSZKI, Pulheim (DE)

(72) Inventors: Patrick NIEHOFF, Bochum (DE); Lutz DECKERT, Haltern am See (DE); Gyula VARHANIOVSZKI, Pulheim (DE)

(21) Appl. No.: 17/568,413

(22) Filed: Jan. 4, 2022

Related U.S. Application Data
(63) Continuation-in-part of application No. PCT/EP2020/067288, filed on Jun. 22, 2020.

(30) Foreign Application Priority Data
Jul. 5, 2019 (DE) 102019118271.9

(51) Int. Cl. B65C 9/18; B65H 35/00; B67C 3/24

(52) U.S. Cl. CPC B65C 9/183; B65H 35/008; B65C 2009/1861; B65H 2701/192; B65C 2009/1838; B67C 3/24

(57) ABSTRACT

A beverage container handling machine, such as a beverage container filling machine or a beverage container closing machine, is used to handle beverage bottles, cans, and similar containers, which containers are configured to hold or contain a beverage, such as water, soft drinks, beer, wine, and juices, or a similar product for transport and consumption by consumers of beverages and similar products.

### CROSS-REFERENCE TO RELATED APPLICATIONS

The present application is a Continuation-in-Part of International Patent Application No. PCT/EP2020/067288, filed Jun. 22, 2020, which claims the benefit of Federal Republic of Germany Patent Application No. DE102019118271.9, filed Jul. 5, 2019, each of which is incorporated by reference herein in its entirety.

### BACKGROUND INFORMATION

### 1. Technical Field

The present application relates to a beverage container handling device for the handling of beverage containers, such as bottles, cans, and similar containers in a beverage bottling plant.

Beverage bottle filling machines, or simply filling machines, are used in the beverage bottle filling or bottling industry to fill bottles with a liquid beverage. Such machines can be of a rotary or linear design. Rotary beverage bottle filling machines include a rotary carousel or rotor or similar structure that has a plurality of individual beverage bottle filling devices or beverage bottle filling stations mounted or positioned on the perimeter or periphery thereof. In operation, an individual beverage bottle is received or picked up from a bottle or container handling device or machine, such as another bottle treatment machine or a container transport or conveyor, which can be either of a rotary or linear design, and held at a corresponding individual filling device or station. While the rotary carousel rotates, each individual filling device or filling station dispenses a beverage, such as soft drinks and sodas, wine, beer, fruit juices, water, or other beverages, or another liquid product. Each individual filling device is usually designed to fill one beverage bottle or similar container at a time. Upon completion of filling, the beverage bottle or container is released or transferred to yet another bottle or container handling device or machine, such as another bottle treatment machine, beverage bottle labeling device, or transport device. The filling devices are therefore designed to fully dispense a predetermined or desired amount or volume of product into the beverage bottles or containers before the beverage bottles or containers reach the exit or transfer position out from the filling machine. The beverage bottle filling machine can also be of a linear design, wherein beverage bottles are moved to one or more filling positions along a straight or linear path.

Such filling machines are usually part of a filling or bottling plant, wherein the filling machine operates in conjunction with a number of other beverage bottle or container handling machines, such as a closing machine for placing caps or closures on filled containers, a container manufacturing machine for making or forming containers to be filled, and a container packaging machine for packaging individual containers for shipment and sale to consumers. Such plants are designed to operate as quickly and continuously as possible, and any interruptions in operation result in a loss of productivity and an increase in operating costs, especially since such plants can process large numbers of containers, such as, for example, anywhere from ten to seventy thousand containers per hour or possibly more.

### 2. Background Art

This section is for informational purposes only and does not necessarily admit that any publications discussed or referred to herein, if any, are prior art.

Some beverage bottling plants simply process beverage bottles and similar containers that have already been manufactured. In other beverage bottling plants, the beverage bottles are formed and manufactured in the plant itself, such as, for example, by blow molding or by glass formation. In these beverage bottling plants, the beverage bottles are treated and prepared for filling with a filling product, which is usually a liquid material, such as a liquid beverage. Such liquid beverages include common consumer beverages, such as beer, soft drinks or soda pop, wine, water, sports drinks, sparkling drinks, carbonated beverages, juices, and flavored drinks.

After filling with a liquid beverage, the beverage bottles are moved to a beverage bottle closing device, such as a closer or capper that applies beverage bottle closures, such as crown caps, crown corks, screw caps, or screw top closures. The beverage bottle closures are either screwed on or pressed on to cover the beverage bottle mouth or opening.

The beverage bottles usually have some sort of information provided on the outside of the beverage bottle, such as a description of the liquid beverage, its brand name, expiration dates or “best if used by” dates, amount of liquid beverage in the container, advertising or promotional information, or similar information. Such information can possibly be placed directly on the outer surface of the beverage bottle or container, or more usually can be placed on a beverage bottle label that is disposed about or on the outer surface of the beverage bottle or container. Once the beverage bottles are filled and closed and contain the appropriate information on the outer surfaces thereof, the beverage bottles are then gathered into groups and packaged for shipping.

The beverage bottle packing or packaging process usually involves arranging the beverage bottles in groups, such as groups of six, twelve, or twenty-four beverage bottles, for example. However, any number of beverage bottles can be placed in a grouping. A beverage bottle packing machine separates the beverage bottles into groups. The groups may be placed in a package, such as a cardboard or paper box or tray, or possibly a plastic container or wrapping, or possibly a combination of different packing materials, such as a cardboard tray with plastic wrapping surrounding the tray and the beverage bottles. The packages of beverage bottles are then usually placed in even larger groups on pallets on or larger containers for shipping to customers.

When adding information to the beverage bottles via beverage bottle labels, the labels can be provided by a supply roll of labels. The supply roll is essentially a single strip of beverage bottle label material that is rolled up on a roll. The single strip of beverage bottle label material has a very large number of individual beverage bottle labels positioned end to end over the entire length of the strip. In order to place the beverage bottle labels on the beverage bottles, the strip is unwound and individual labels are removed from the strip as it is unwound. Individual labels are then placed on each beverage bottle by a beverage bottle labeling device or unit. In order to separate individual beverage bottle labels from the strip, a cutting unit, device, or arrangement can be used to cut through the material in between individual beverage bottle labels on the strip. In this manner, a single label is cut off of the strip of labels, which single label is then placed on a beverage bottle. This process is repeated for each beverage bottle as the supply roll is continuously unwound. Before the supply roll is completely unwound, a new supply roll of beverage bottle labeling material is placed in the labeling machine to ensure uninterrupted labeling of beverage bottles.

For the separation of individual beverage bottle labels from the label strip, cutting units are used for the labeling of bottles or similar containers with what are referred to as roll-fed labels, which in each case are produced by drawing off and separation of a label length from an endless label material. These units comprise, for example, a cutting drum with at least one cutting drum blade on the drum peripheral surface and a blade shaft with at least one counter-blade.

In one type of labeling machine, for the cutting process, the cutting drum and the blade shaft are driven so as to circulate in synchrony, or essentially or substantially in a synchronized manner, about their axes arranged parallel to one another, and specifically in such a way that the blade shaft circulates in counter-direction to the cutting drum.

During the cutting process the two cutting edges of the blade element, forming the cutting gap, namely the fixed and the rotating blade element, are arranged in such a way that they lie immediately opposite one another, but are only just still not touching, such that, in at least one embodiment, the width of the cutting gap is practically zero. It should be understood that the cutting gap or cutting distance, in the context of this application, refers to the distance between the two cutting edges when the cutting edges are immediately adjacent one another in a cutting position or area in which the cutting edges interact to cut or separate an individual label from the strip of labels or label material, which distance may be zero, that is, the edges touch or contact one another, at least in part along the length thereof, or which distance is greater than zero, that is, the edges do not touch or contact one another at all. In any event, it is desirable or optimal for the cutting gap to be configured as substantially smaller than the thickness of the label material in the form of a web or strip, and specifically over the entire length of the cutting gap. In other words, there is a rotating blade element and a fixed or stationary blade element, which are arranged or disposed or positioned such that, when the rotating blade element is moved past the stationary blade element, the edges of the two blade elements are temporarily very close together. The space or gap between the edges of the two blade elements at this point is so small as to be less than the thickness of the label material, such that the interaction of the two blade elements cuts through the label material to separate off an individual label. The gap when the edges are at their closes to one another is so very small it practically approaches zero and visually appears to be nonexistent, though the two blade elements are positioned such that the edges do not actually touch or contact one another. The width of the cutting edges is such that the strip of label material can be cut all the way across its width in one cutting operation to quickly separate the individual label from the strip.

The length of the cutting gap is at least the same as, but possibly greater than, the width of the strip-like label material. Any contact of the cutting edges of the two blade elements during the adjustment process or during the cutting process leads to increased wear or destruction of the blade elements. With a very thin label material, for example, with material thicknesses of only 4/100 mm or less, such as is usual with label materials for film labels, the adjustment of the cutting gap is extremely difficult and time-consuming, and usually can only be carried out reliably or effectively by highly trained specialist personnel.

In order to achieve problem-free cutting, or at least cutting with minimized errors or interruptions, and also optionally or additionally to prevent or minimize mutual damage of the blades, an adjustment can be made to the cutting gap, i.e., the distance interval which the interacting blades exhibit from one another during the cutting process. This adjustment is carried out, for example, by an adjustment of the rotation angle of the blade shaft, i.e. in that, with the cutting drum blade being in the cutting position, the rotational setting of the blade shaft which corresponds to this cutting drum rotation setting is changed in such a way that the desired cutting gap is as narrow as can possibly be achieved without any risk of damage to the blades, or at least with a minimal risk of damage to the blades.

The rotational angle adjustment can be achieved, for example, mechanically by use of the gear which drives the blade shaft, which for this purpose comprises a corresponding rotation angle setting assembly configured for adjusting the rotation angle and which can be actuated for the rotation angle adjustment. Adjustment can also be achieved in other embodiments of cutting units, for example, such with stationary, i.e., non-circulating counter-blade carriers, such as a blade shaft, which, for example, carries out a controlled oscillating back-and-forth movement.

In at least one type of cutting device, the cutting device comprises rotating and interacting wing blades with fixed counter-blades for producing shaped cuts into the edges of moving material webs, such as into the edges of paper webs for producing envelopes or blanks. The respective interacting blades consist of materials of different hardness, in such a way that the softer blade can have material removed from it by the harder blade, without damage being incurred by the harder blade. At least one of the blades of the interacting pair of blades in each case is mounted in such a way that it can be adjusted in relation to its counter-blade with the cutting device still running.

In another type of cutting device, fixed blade elements are made from aluminum and have an anodized surface. In this situation, these are provided with a hard-anodized layer which produces the required surface hardness. However, this coating can only be formed as a few micrometers in thickness, and can break off when the base material is carried away by abrasion. Accordingly, these blade elements can only be used on the fixed-position side, since here the label material is not constantly grinding over the cutting edge, but only comes in contact at the point of intersection with the rotating blade element and with the label which is to be cut.

Although this already could allow for the achievement of a basic improvement in the working life, i.e., the number of cuts between two adjustment procedures, a still further increase in working life could possibly be achieved to generate additional cost savings.

### SUMMARY

An object of the present application is to describe a beverage bottling device for the handling of beverage bottles and similar containers in a beverage bottling plant. Another object of the present application is to provide a cutting unit for a beverage bottle labeling device which, while maintaining the self-sharpening capacity of such a cutting unit, also substantially increases the wear resistance and therefore the working life of the blades being used, and therefore in turn the number of cuts which can be carried out between two adjustment processes. A further object of the present application is to provide a beverage bottle labeling device with such a cutting unit. Another object of the present application is to describe a method of operating beverage bottling device for the handling of beverage bottles and similar containers in a beverage bottling plant.

These objects can be achieved by a beverage bottling device or method of operation thereof in accordance with at least one possible exemplary embodiment disclosed herein.

In accordance with at least one possible exemplary embodiment, a cutting unit for a labeling device of a labeling machine, comprising a cutting drum which can be driven such as the circulate about a drum axis, with at least one first blade element provided at a drum periphery, with at least one first cutting edge, which, for the cutting of a label, interacts with at least one second cutting edge of a second blade element provided at a switching and adjusting device, with the formation of a cutting gap. In this situation the second blade element comprises, at least in the region of its second cutting edge, a second hardness, which is configured as greater than the first hardness, at least in the region of the first cutting edge of the first blade element.

Moreover, the first cutting edge of the first blade element can be produced by material removal on the second cutting edge of the second blade element with the second harder degree of hardness. In accordance with at least one possible exemplary embodiment, the first blade element is formed, at least in the region of its first cutting blade, from a steel from the group of cold-work steels, and the second blade element is formed, at least in the region of its second cutting edge, from a carbide metal. This specific material pairing on the respective cutting edges of the two blade elements is such that material is removed from the stationary blade element but, on the other hand, the abrasive properties of the label strip that is to be cut are essentially or substantially resisted. Accordingly, while maintaining the self-sharpening capacity of the cutting unit, the wear resistance and therefore the working life of the blade elements used are substantially increased, and therefore in turn the number of the cuts which can be carried out between two adjustment processes, in relation to other similar cutting devices.

According to at least one possible exemplary embodiment, the first blade element is formed or manufactured from a full material of a steel from the group of cold-work steels and/or the second blade element from a full material of a carbide metal.

According to at least one possible exemplary embodiment, the second blade element is manufactured at least in the region of its second cutting edge from a carbide steel or tool steel or ceramics.

According to at least one possible exemplary embodiment, the steel from the group of cold-work steels is an unalloyed or alloyed cold-work steel.

According to at least one possible exemplary embodiment, the steel from the group of cold-work steels exhibits a first hardness, according to the hardness on Rockwell scale C (HRC), from 55 HRC to 59 HRC.

According to at least one possible exemplary embodiment, the steel from the group of cold-work steel is configured as a cold-work steel with the material number EN 1.2550 (DIN 60WCrV7, AISI S1), or as a cold-work steel with the material number EN 1.2379 (DIN X153CrMoV12, AISI D2), or as a cold-work steel with the material number EN 1.4034 (DIN X46Cr13, AISI 420). The abbreviation “EN” refers to the European Norm standard, “DIN” refers to the German standard established by the Deutsches Institut für Normung, and the abbreviation “AISI” refers to the American Iron and Steel Institute standard.

According to at least one possible exemplary embodiment, the steel from the group of cold-work steels is configured as a cold-work steel Vanadis® 10 or Viking, with a chemical composition of C 0.5%, Si 1%, Mn 0.5%, Cr 8%, Mo 1.5%, and V 0.5%, manufactured by Uddeholm AB, headquartered at Uvedsvägen, 683 85 Hagfors, Swede.

According to at least one possible exemplary embodiment, the second blade element is produced at least in the region of its second cutting edge from a carbide metal which is configured as a metal matrix composite material.

According to at least one possible exemplary embodiment, the second blade element is produced from a carbide metal which is configured as a tungsten-carbide carbide metal type (WC—Co) and/or as a carbide metal type for steel working (WC—(Ti, Ta, Nb)C—Co) and/or as a cermet carbide metal type.

According to at least one possible exemplary embodiment, the carbide metal of the second blade element comprises a second hardness according to Vickers of 1150 (Vickers Pyramid Number HV30) and/or a fracture toughness according to Palmqvist of 15.5 MN/mm (meganewtons per millimeter).

According to at least one possible exemplary embodiment, for a cutting unit for a labeling device of a labeling machine which comprises a cutting drum, driven such as to circulate about a drum axis, with at least one first blade provided at a drum periphery. In this situation, in order to cut a label the first blade can be moved past a counter-blade which is provided at a switching and adjusting device. Moreover, the counter-blade can be pivoted in a controlled manner, by use of a first joint section formed at the switching and adjusting device, between a cutting position and a waiting position in such a way that in the cutting position the counter-blade is in working engagement with the rotating first blade, and in the waiting position is out of working engagement. Conjointly, by use of a second joint section formed at the switching and adjusting device, in the cutting position the blade gap formed between the first blade and the counter-blade can be adjusted independently of the controlled pivot position of the first joint section. In this way not only can the counter-blade be brought out of working engagement with the first blade, but also the blade gap can be adjusted. Inasmuch as two jointed sections are formed for this purpose at the switching and adjusting device, both function procedures can be adjusted independently of one another.

According to at least one possible exemplary embodiment, the switching and adjusting device is configured such as to pivot the first joint section between the cutting position and the waiting position in a controlled manner in such a way that, in the event of isolated gaps occurring in the bottle stream of the labeling device, for this one empty, unoccupied container handling position at the rotor no label will be cut. In other words, if a bottle is not present in a bottle handling or support device when moved into position for a label to be applied, the cutting device is temporarily moved from a cutting position, in which the blades interact to cut off a label, to a waiting position, in which the blades are a distance apart from one another and thus cannot interact with one another to cut off a label. In this manner, an individual label is not cut off from the label strip when a bottle is not present to be labeled, thereby minimizing waste of label material.

According to at least one possible exemplary embodiment, the switching and adjusting device comprises a U-profile shaped solid body joint, at which the first and second joint sections are formed.

According to at least one possible exemplary embodiment, the solid body joint comprises a first side limb section, a second side limb section oriented essentially or substantially parallel to the first side limb section, and a base limb section connecting the two side limb sections at a free end.

According to at least one possible exemplary embodiment, the first joint section is formed at the solid body joint in the transition region between the first side limb section and the base limb section, and the second joint section is formed in the transition region between the two side limb sections and the base limb section, and that the solid body joint is configured such as to be elastically deformable at least in its respective joint section.

According to at least one possible exemplary embodiment, the solid body joint is configured as being of one part, and in particular as one piece.

According to at least one possible exemplary embodiment, the switching and adjusting device is secured by a holder element, itself secured to the first side limb section, immovably or in a fixed or stationary manner on a housing of the cutting unit.

According to at least one possible exemplary embodiment, the switching and adjusting device comprises an essentially L-shaped extended switching lever element, which, in order to initiate a pivoting movement between the cutting position and the waiting position onto the counter-blade, is connected on a first side to the base limb section, and with a second side interacts directly or indirectly with a switching device in such a way that, at the initiation of a setting movement by the switching device, the switching lever element can be pivoted in a controlled manner about the first joint section.

According to at least one possible exemplary embodiment, the switching lever element comprises, in the region of its free end section of the second side, a mechanical stop, by use of which the deflection of the switching lever element can be adjusted between the waiting position and the cutting position.

According to at least one possible exemplary embodiment, the switching and adjusting device comprises, on its second side limb section of the fixed body joint, a blade holder, at which the counter-blade is held in such a way that the counter-blade, at a controlled pivot movement about the first joint region, can be pivoted in a manner directly proportional to the deflection of the switching element.

According to at least one possible exemplary embodiment, the relative positioning of the blade holder provided at the second side limb section can be fixed immovably to the switching lever element by use of a locking plate.

According to at least one possible exemplary embodiment, the blade holder, including the counter-blade held on it, in order to adjust the blade gap, is configured so as to be capable of pivoting about the second joint section relative to the switching lever element by use of an adjustment device provided at the blade holder.

According to at least one possible exemplary embodiment, the adjustment device comprises a threaded spindle with a differential thread, wherein the threaded spindle provides along its shaft at least one first thread section and a second thread section, which both exhibit the same thread direction but with different thread pitches, wherein the first thread section of the threaded spindle is accommodated in a counter-thread of the blade holder, and the second thread section is accommodated in a counter-thread of the switching lever element.

The expression “essentially” or “approximately” signifies in the meaning of the invention deviations from the exact value in each case by +/−10%, preferably by +/−5%, and/or deviations in the form of changes which are not of significance for the function. Further embodiments, advantages, and possible applications of the invention also derive from the following description of exemplary embodiments and from the Figures. In this context, all the features described and/or represented in images are in principle the object of the invention, alone or in any desired combination, regardless of their association in the claims or reference to them. The contents of the claims are also deemed to be a constituent part of the description.

Although some aspects have been described in connection with a device, it is understood that these aspects also represent a description of the corresponding method, such that a block element or a structural element of a device is also to be understood as a corresponding method step or as a feature of a method step. By analogy, aspects which have been described in connection with or as a method step also represent a description of a corresponding block or detail or feature of a corresponding device. Some or all of the method steps can be carried out by a hardware apparatus or with the use of a hardware apparatus, such as, for example, a microprocessor, a programmable computer, or an electronic circuit. In some exemplary embodiments some or a plurality of the method steps can be carried out by such an apparatus.

### BRIEF DESCRIPTION OF THE DRAWINGS

FIG. 1 shows a view from above of a schematic representation of a labeling device of a labeling machine for the labeling of containers, in accordance with at least one possible exemplary embodiment;

FIG. 1A shows a schematic top view of a container handling or beverage bottling machine, in accordance with at least one possible exemplary embodiment;

FIG. 2 shows an exemplary embodiment variant of a cutting unit, in a schematic view from above;

FIG. 3 shows an enlarged view of the region X of the cutting unit in FIG. 2;

FIG. 4 shows a schematic representation of the enlarged section represented in FIG. 3;

FIG. 5 shows an exemplary embodiment variant of a cutting unit according to at least one possible exemplary embodiment, in a schematic view from above;

FIG. 6 shows, in a schematic side view, an exemplary embodiment variant of a switching and adjusting device of a cutting unit;

FIG. 7 shows, in a schematic view from above, the switching and adjusting device according to FIG. 6; and

FIG. 8 shows, in a schematic perspective view, the switching and adjusting device according to FIG. 6.

### DETAILED DESCRIPTION

Identical reference numbers are used in the drawings for elements which are the same or have the same effect. Moreover, for the sake of easier overview, only reference numbers are represented in the individual figures which are necessary for the description of the respective figure. At least one possible exemplary embodiment is also represented in the figures only as a schematic view in order to explain the method of working. In general, the representations in the figures may serve only to explain one or more underlying principles of at least one possible exemplary embodiment. For reasons of easier overview, the representation of some of the component parts of the device has been avoided.

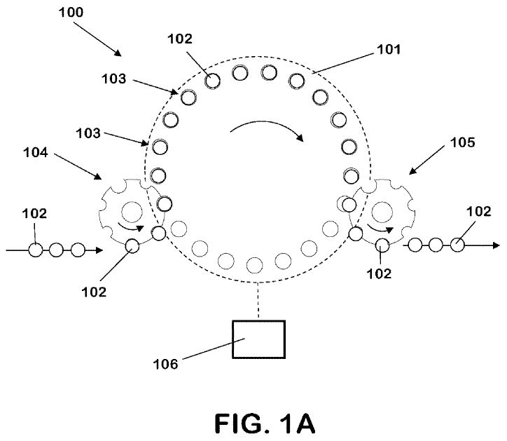

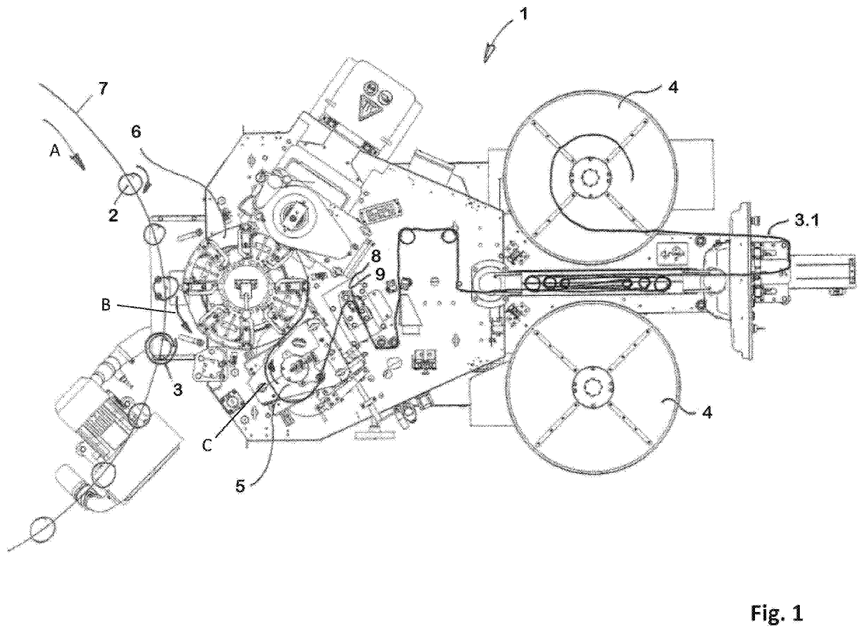

FIG. 1A shows a schematic top view of a container handling or beverage bottling machine 100 for handling containers 102, such as bottles, cans, kegs, or similar containers, in accordance with at least one possible exemplary embodiment. The container handling machine 100 comprises a rotor or carousel 101 designed to rotate about a vertical axis of rotation. A plurality of container handling arrangements 103 are disposed about the periphery of the rotor 101. The container handling arrangements 103 can be designed to perform different functions depending on the container handling machine 100, such as container filling, closing, labeling, and other such container handling functions. A first rotary container transport device 104, such as a star wheel or similar device, moves containers 102 into the container handling arrangements 103. A second rotary container output device 105, such as a star wheel or similar device, moves containers 102 out of the container handling arrangements 103. A control arrangement 106, such as a computer control arrangement, is operatively connected to the container handling machine 100 to control and/or monitor the operation of the container handling machine 100 and the components thereof.

FIG. 1 shows a labeling device or unit or arrangement 1 of a labeling machine for the labeling of bottles or similar containers 2 with what are referred to as roll-fed labels 3, which are drawn off from a supply roll 4 of an endless strip-form labeling material 3.1. The labels 3 are cut off in the respective length of the labeling material 3.1 necessary for a label 3 by use of a cutting unit 5 of the labeling device 1. The labels 3 obtained in this way are transferred over a labeling and transfer drum 6 to the containers 2, which are being moved past on a rotor 7 of the labeling machine at the labeling unit 1, circulating about a vertical machine axis, and then applied to the containers 2. The directions of rotation of the rotor 7 and of the transfer drum 6 are indicated by the arrows A and B respectively.

The label material 3 is drawn from a supply roll 4 by use of conveying rollers 8 and 9, in synchrony with the movement of rotation of the rotor 7, and fed to the cutting unit 5. The cutting unit 5 comprises a cutting drum 10, which during the labeling is driven such as to circulate about a drum axis TA in the manner represented by arrow C, which is in the counter-direction to the direction of rotation B of the transfer drum 6. This cutting drum 10 is the same as or similar to other cutting drums that are generally well known in the beverage bottling industry, so a more detailed description has therefore been avoided.

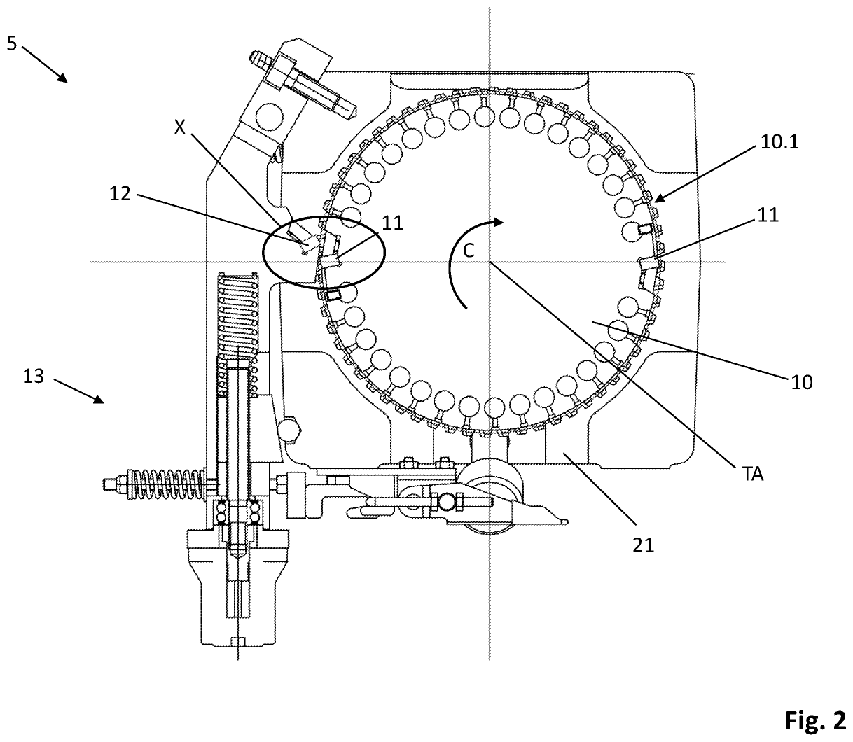

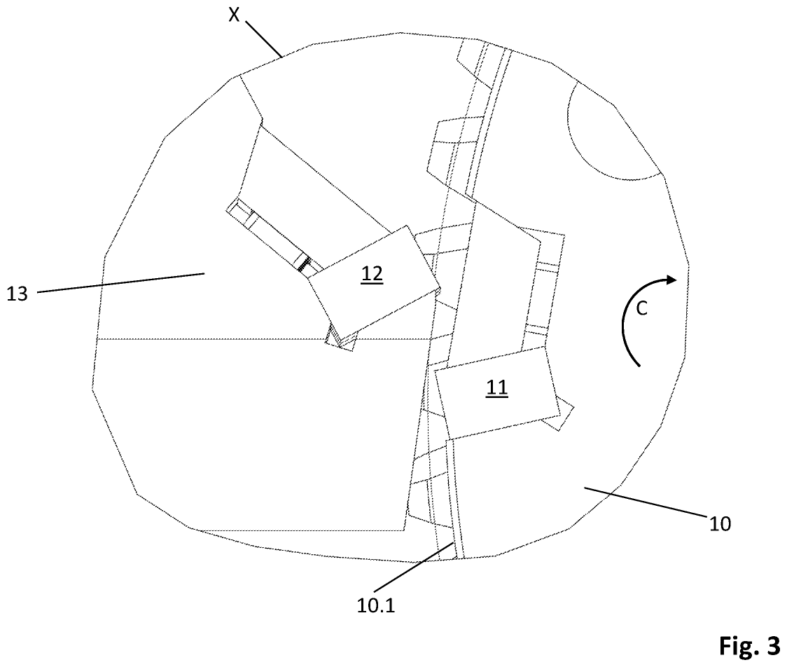

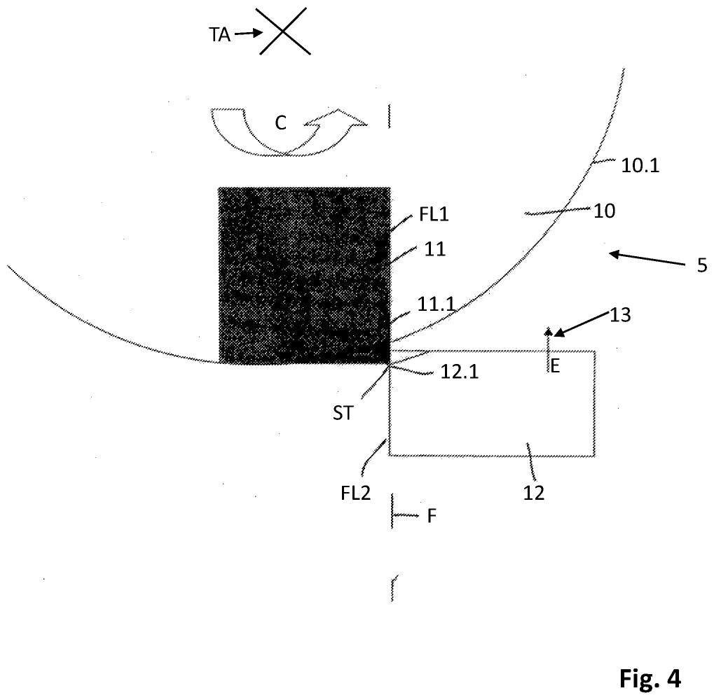

As seen in FIG. 2, the cutting drum 10, about its periphery, has a drum peripheral surface 10.1 that is generally circular or generally in the form of a circular cylinder. At this periphery or peripheral surface 10.1, the cutting drum 10 comprises two first blade elements 11 disposed opposite to one another with respect to the drum axis TA, although any number of first blade elements 11 could be included in at least one possible exemplary embodiment. FIG. 3 shows an enlarged or close up view of the area within the circle X in FIG. 2. As shown in a schematic or operational or representative view in FIG. 4, each of the first blade elements 11 comprises a first cutting edge 11.1 and is oriented or disposed or positioned such that the first cutting edge 11.1 is parallel or essentially parallel or substantially parallel to the drum axis TA of the cutting drum 1. Each of the first blade elements 11 is designed and positioned to interact with at least one blade element 12, which comprises a second cutting edge 12.1. The blade elements 11, 12 define a cutting gap ST and interact in such a way that, at a rotation of the cutting drum 10, due to the interaction of the first cutting edge 11.1 of the first blade element 11 with the second cutting edge 12.1 of the second blade element 12, the length of label material 3.1 which forms the label 3 is cut off to form an individual label 3. The label 3 is then temporarily held on the peripheral surface 10.1 of the cutting drum 10, for example by vacuum, and transferred to the transfer drum 6.

In other words, the cutting unit 5 therefore cuts a label 3, in that the rotating first blade element 11, provided at a drum periphery 10.1 of the cutting drum 10, moves past at the second blade element 12, provided at a switching and adjusting device 13 and functioning as a counter-blade, and the cut therefore takes place.

In greater detail, with respect to the exemplary embodiment represented in FIG. 4, the first cutting edge 11.1 is formed at a first flat side surface FL1 of the first blade element 11, preceding in the direction of rotation C of the cutting drum 10, or of the part region of this first blade element 11 projecting over the drum periphery surface 10.1. The first cutting edge 11.1 is oriented and positioned such that, upon the cutting drum 10 being driven such as to circulate, the first cutting edge 11.1 essentially or substantially moves on a path concentrically surrounding the vertical drum axis TA in the form of a circle or circular cylinder. In accordance with at least one possible exemplary embodiment, the first cutting edge 11.1 is also oriented parallel to the drum axis TA.

Allocated to the first rotating blade element 11 or to its first cutting edge 11.1 is a second blade element 12, taking effect as a counter-blade, with a second cutting edge 12.1. The second blade element 12 does not circulate with the cutting drum 10 at the cutting unit 5, wherein it is disposed in a fixed or stationary position relative to the cutting drum 10. and specifically at the switching and adjusting device 13, in such a way that the second blade element 12, or, respectively, its second cutting edge 12.1, can be adjusted radially or approximately radially in relation to the circulating drum 10 (arrow E). For an adjustment setting, the second blade element 12 or its second cutting edge 12.1 respectively, can be adjusted, for example, in such a way that the second blade element 12, or its cutting edge already present immediately after installation into the cutting unit 5, is oriented at least approximately parallel to the first cutting edge 11.1 when this is located directly at the second cutting edge 12.1.

In accordance with at least one possible exemplary embodiment, the first and second cutting edges 11.1, 12.1, are provided as restricted in relation to one another in their respective longitudinal extension along the drum axis TA, i.e., are not parallel. In accordance with at least one possible exemplary embodiment, the first and second cutting edges 11.1, 12.1, are provided as mutually restricted by 0.2 mm to 0.7 mm, such as by approximately 0.5 mm, over their respective longitudinal extensions, in such a way that a contact in point form can be produced between the two cutting edges 11.1, 12.1. In other words, in accordance with at least one possible exemplary embodiment, when the first and second cutting edges 11.1, 12.1 meet or are disposed adjacent one another in a cutting process, the edges are not oriented parallel to one another, that is, one edge is offset or at an angle to the other, such that the edges are oriented transverse to one another and would appear to cross or overlap one another. Accordingly, instead of the edges being aligned across their length or substantially their entire length, only a portion of the edges intersect or overlap with one another. This positioning is not unlike the positioning of the blades of a pair of scissors, wherein the individual blades are offset such that they intersect or cross or overlap over a limited or restricted area or point at any given time as the blades are moved with respect to one another in a cutting process. This offset design of scissors allows the blades to gradually cut across an item being cut, rather than the blades meeting across their entire lengths in a chopping motion, such as when a flat knife or cleaver is brought down upon a parallel cutting service or chopping block in a perpendicular motion. Therefore, in accordance with at least one possible exemplary embodiment, the first and second cutting edges 11.1, 12.1, as the first blade element 11 is moved past the second blade element 12, the first and second cutting edges 11.1, 12.1 meet or intersect or cross or overlap or lie transverse to one another over a point or a limited or restricted area in the range of about or exactly 0.2 mm to 0.7 mm, including values in tenths and hundredths of a millimeter. In accordance with at least one possible exemplary embodiment, this point or area could be about or exactly 0.5 mm, which includes values in tenths or hundredths of a millimeter down to 0.4 mm or up to 0.6 mm. This intersection point or area is essentially where the first and second cutting edges 11.1, 12.1 interact to cut the label material. An example of this offset can be seen in the close up view in FIG. 3, wherein the sides of the first blade element 11 are parallel or essentially parallel to the drum axis TA, and thus not visible from the top view in FIG. 3 along the drum axis TA. In contrast, the sides of the second blade element 12 are not parallel or are at an angle to the drum axis TA, and thus portions of two of the sides are visible from the top view in FIG. 3 along the drum axis TA. However, this positioning is in accordance with at least one possible exemplary embodiment and other positions or orientation of the blade elements 11, 12 are possible to achieve different cutting relationships and processes. For example, the cutting edges 11.1, 12.1 can be oriented parallel, or essentially parallel, or substantially parallel to one another and/or the drum axis TA.

In this situation, a cutting gap ST is formed between the first cutting edge 11.1 and the second cutting edge 12.1, and specifically in such a way that at each cutting process, i.e., with the cutting drum 10 rotating, whenever the first blade element 11, rotating with the cutting drum 10 in a torsionally-resistant or rotationally-fixed manner, moves past the second fixed-positioned blade element 12, the first and second cutting edges 11.1 and 12.1 just come in contact, or just do not come in contact, and preferably over the entire length of the cutting gap ST extending in the direction of the drum axis TA. In other words, the first and second blade elements 11, 12 are positioned such that the first and second cutting edges 11.1, 12.1, during the cutting process, barely or very slightly or minimally contact one another, or they come very close to contacting one another, such that the label material is cut but the first and second cutting edges 11.1, 12.1 do not contact each other at all.

The length of the cutting gap ST in this situation is at least equal to, or possibly greater than, the width of the band-form or web-form label material 3.1. In this situation, the band-form or web-form label material 3.1 moves through the cutting gap ST in the direction of the transfer drum 6, and is, for example, at least in the region of the cutting gap ST, oriented in or essentially in or substantially in a plane F parallel to the drum axis TA.

In order to adjust and/or align the cutting gap ST, provision is made in this situation for the second measuring element 12 to comprise at least in the region of its second cutting edge 12.1 a second hardness, which is configured as greater than a first hardness at least in the region of the first cutting edge 11.1 of the first blade element 11. Accordingly, the fixed position second blade element 12 is configured, at least in the region of its second cutting edge 12.1, as harder than the rotating first blade element 11 in the region of its first cutting edge 11.1. Accordingly, the first cutting edge 11.1 of the first blade element 11 can be produced by material removal at the second cutting edge 12.1 of the second blade element 12 with the greater second hardness. In other words, in accordance with at least one possible exemplary embodiment, the second cutting edge 12.1, due to its greater hardness, can be used to form and/or sharpen the first cutting edge 11.1, due to its lesser hardness.

According to at least one possible exemplary embodiment, the first blade element 11 is formed, at least in the region of its first cutting edge 11.1, from a steel, such as a steel of the group of the cold-work steels, and the second blade element 12 is formed, at least in the region of its second cutting edge 12.1, from a carbide metal.

In order to achieve the required cutting gap ST by material removal, therefore, the second blade element 12 is produced, at least in its cutting region forming the second cutting edge 12.1, with a hardness which is greater in comparison with the first hardness, in that it is manufactured from carbide metal, for example from hardened steel, tool steel, or ceramics, while the first blade element 11 is manufactured from a material which is softer in comparison with the cutting region of the second blade element 12, namely a steel from the group of the cold-work steels.

In this situation, the first blade element 11 is formed or manufactured from a full material of a steel from the group of the cold-work steels, and/or the second blade element 12 from a full material of a carbide metal. In other words, in accordance with at least one possible exemplary embodiment, the first blade element 11 can be made entirely from a steel from the group of the cold-work steels, and the second blade element 12 can be made entirely from a carbide metal.

The steel from the group of the cold-work steels can be an unalloyed or alloyed cold-work steel.

The steel from the group of the cold-work steels exhibits a first hardness according to Rockwell of 55 HRC to 59 HRC. The inventors discovered, after substantial testing, that with a first hardness of over 59 HRC it is no longer possible for adequate material to be removed for the subsequent sharpening of the cutting edges. The inventors also discovered that, with a first hardness of less than 55 HRC, both the blade elements 11, 12 can indeed be well sharpened subsequently, but the wear increases disproportionately due to the abrasive surface of the label material.

In accordance with at least one possible exemplary embodiment, the steel from the group of the cold-work steels is configured as a cold-work steel with the material number EN 1.2550 (DIN 60WCrV7, AISI S1), or as a cold-work steel with the material EN 1.2379 (DIN X153CrMoV12, AISI D2), or as a cold-work steel with the material number EN 1.4034 (DIN X46Cr13, AISI 420). The steel from the group of the cold-work steels can also be configured as the cold-work steel Vanadis® 10 or Viking, with a chemical composition of C 0.5%, Si 1%, Mn 0.5%, Cr 8%, Mo 1.5%, and V 0.5%.

As a carbide metal used for the second blade element 12, in the present case a metallic material is understood to be a metal matrix composite material in which the hard materials, which are present as small particles, are held together by a matrix of metal. The carbide metal accordingly exhibits a high degree of toughness.

The carbide metal of the second blade element 12 can be configured as a tungsten carbide-cobalt carbide metal type (WC—Co) and/or as a carbide metal type for steel working (WC—(Ti,Ta,Nb)C—Co) and/or as a Cermet carbide metal type.

By contrast with conventional cutting materials, such as high-speed steels, carbide metals exhibit a lesser fracture toughness and thermal shock resistance. Conversely, however, they have significant advantages such as greater hardness and temperature resistance. In particular, the high degree of hardness leads to a high abrasive wear resistance. This alone allows for higher cutting speeds. These can also be achieved, since carbide metals can exhibit a temperature resistance of up to 1100 degrees Celsius.

Advantageously, the carbide metal exhibits in this situation a second hardness according to Vickers of 1150 (HV30) and/or a fracture toughness according to Palmqvist of 15.5 MN/mm. Accordingly, the carbide metal exhibits an adequate degree of toughness such that, at the impacting stress incurred when the two blade elements 11, 12, come in contact, no or essentially no or very little or a minimal amount of material will break off from the cutting edges.

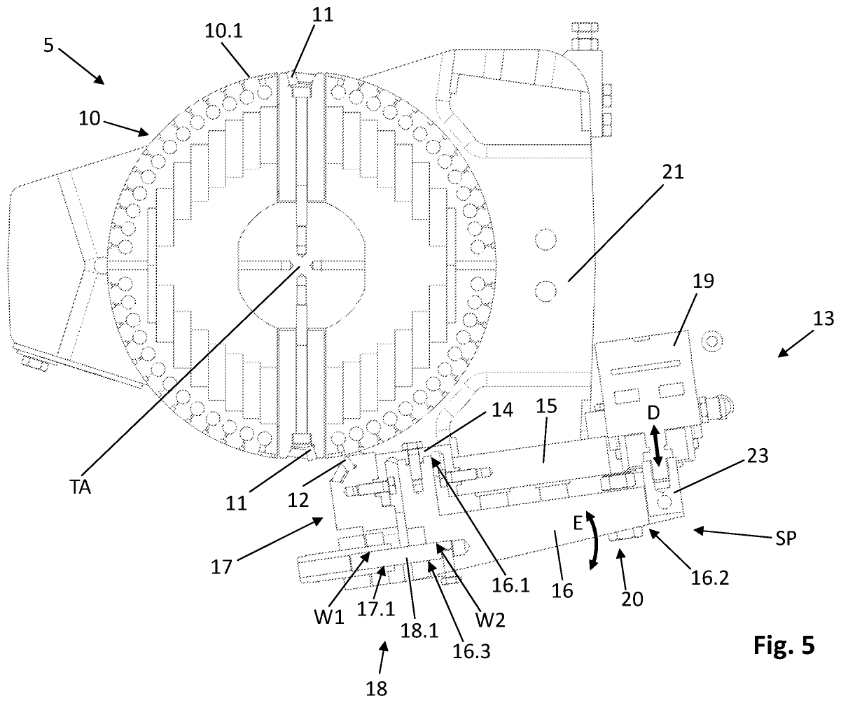

When the cutting device is first taken into operation, for example also after a replacement of function elements of the cutting device 1, such as of one of the blade elements 11 and 12, there is first a rough adjustment of these blade elements, or possibly only one of the blade elements, such as only the second blade element 12 as in the embodiment shown in FIG. 5, in such a way that the second blade element 12 is oriented at least approximately parallel to the first blade element 11 or to its cutting edge 11.1 respectively. This adjustment can be carried out by use of the switching and adjusting device 13. Next, with the cutting drum 10 revolving, an adjustment is carried out of the second blade element 12, such that, with the second cutting edge 12.1, by the removal of material at the first blade element 11, the first cutting edge 11.1 is formed. The adjustment of the second blade element 12 to the circulating cutting drum 10 by use of the switching and adjusting device 13 is then ended when the first cutting edge 11.1, produced by the removal of material, extends over the entire length of the cutting gap ST, and the cutting gap ST is configured over its entire length in such a way that the second cutting edge 12.1, and the first cutting edge 11.1, formed by the removal of material, at each movement of the blade element 11 past the blade element 12, just come in contact over the entire length of the cutting gap ST, or, likewise, no longer just come in contact. On the basis of cutting samples of the label material 3.1, the appropriate formation of the cutting edge 11.1 can be monitored and determined, and the adjustment of the second blade element 12 is then ended when the formation of the first cutting 11.1 is concluded by the material removal produced by the second cutting edge 12, or when the cutting process for the detachment of a label is taking place over the entire label width uniformly and without any defects, or at least with a minimal number of defects within manufacturing tolerances.

During the operation of the cutting device, a slight manual readjustment or setting of the second blade element 12 can be carried out, for example, by use of the switching and adjusting device 13, in order to re-sharpen the first cutting edge 11.1. In other words, the positioning of the second blade element 12 can be adjusted either while the cutting drum 10 is rotating or while the cutting drum 10 is stationary.

In this situation, provision can also be made that, time-controlled and/or as a dependency of the number of cuts carried out, i.e., in each case after a predetermined number of cutting procedures, an automatic slight readjustment or setting of the second blade element 12 can be carried out in the direction of the first cutting edge 11 by use of the switching and adjusting device 13, in order to re-sharpen its cutting edge, i.e., in order to avoid the second cutting edge 12 being worn away by the abrasion. In other words, the position of the second blade element 12 can be adjusted automatically on a schedule, or it can be manually or individually adjusted as needed.

In order to form the first cutting edge 11.1, the second blade element 12 comprises a flat surface FL2 in a plane F, in which, as the first blade element 11 moves past the second blade element 12, the first cutting edge 11.1 and/or its first flat side surface FL1 of the first blade element 11 are also arranged, and which extends transversely to the direction of movement of the first cutting edge 11.1 when moving past at the second blade element 12, i.e., the plane F extends approximately radially to the machine axis TA, or essentially parallel to a radius of the machine axis TA.

There is also the possibility for the first and/or second blade element 11, 12 to be treated and/or coated at least in part regions on the surfaces, in order to produce their corresponding first and/or second hardnesses.

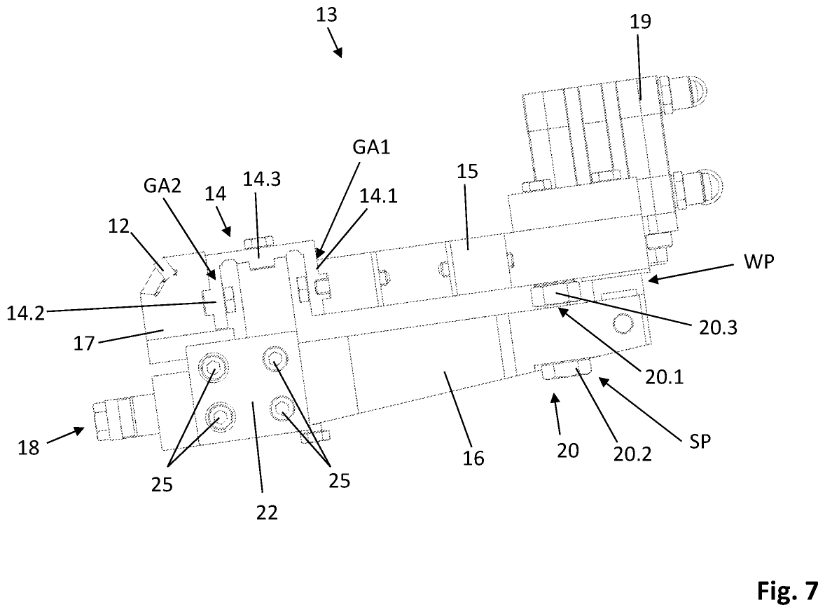

FIGS. 5-8 show at least one possible exemplary embodiment of a labeling machine and components thereof. In order to adjust the cutting gap ST, provision can be made in this situation for the second blade element 12 to be pivoted, by use of a first joint section GA1 formed at the switching and adjusting device 13, between a cutting position SP and a waiting position WP, in a controlled manner. When the second blade element 12 is in the cutting position SP, it is in working engagement with the rotating first blade element 11, i.e., they are interacting and thus cutting labels 3, while when the second blade element 12 is in the waiting position WP, it is out of working engagement with the blade element 11, i.e., they are not interacting and thus not cutting any labels 3.

Moreover, by use of a second joint section GA2, formed at the switching and adjusting device 13, the cutting gap ST, formed between the first blade element 11 and the second blade element 12, can be adjusted independently of the controlled pivot movement of the first joint section GA1.

In this situation, the switching and adjusting device 13 can be configured in such a way as to pivot the first joint section GA1 between the cutting position SP and the waiting position WP in a controlled manner in such a way that, in the event of isolated gaps occurring in the bottle stream of the labeling device 1, no label will be cut for at least this one empty unoccupied container handling position at the rotor 7, with the second blade element 12 therefore being taken out of engagement for a short period with the first blade element 11 provided at the cutting drum.

In greater detail, the cutting unit 5 comprises a housing 21, in which all or essentially all of the components and modules are arranged or accommodated. In accordance with at least one possible exemplary embodiment, the switching and adjusting device 13 is arranged in the housing 21 by use of a plate-shaped holder 15, which may be screwed to the housing 21 in a detachable manner. In turn, all the components and modules of the switching and adjusting device 13 explained in greater detail hereinafter are held on or mounted on or supported by the plate-shaped holder 15.

In this situation, a switching device 19 is provided on the plate-shaped holder 15 for the controlled pivotable movement of the first joint section GA1 between the cutting position SP and the waiting position WP of the second blade element 12. In accordance with at least one possible exemplary embodiment, the switching device 19 is configured as a pneumatic cylinder device, which can produce an adjustment movement on both sides or in two directions, identified by a double arrow D.

Provided on the side opposite the switching device 19, on the holder 15, is a solid body joint 14, with an essentially U-shaped profile, formed on which are the first and second joint sections GA1, GA2. In greater detail, the U-profile shaped solid body joint 14 comprises in this situation a first side limb section 14.1, with which the solid body joint 14 is arranged at the holder 15. In the embodiment shown, the solid body joint 14 is secured to the holder 15 in a detachable manner, for example by being screwed to it. Further provided is a second side limb section 14.2, oriented essentially parallel to the first side limb section 14.1, wherein both the side limb sections 14.1, 14.2 are connected to one another by a third base limb section 14.3, which runs or is oriented perpendicular or essentially or substantially perpendicular to the two side limb sections 14.1, 14.2.

In greater detail, in this situation the first joint section GA1 is formed on the solid body joint 14 in the transition region between the first side limb section 14.1 and the base limb section 14.3, and the second side limb section GA2 is formed in the transition region between the second side limb section 14.2 and the base limb section 14.3. In accordance with at least one possible exemplary embodiment, the solid body joint 14 is configured, at least in its respective joint sections GA1, GA2, as being elastically deformable. In other words, the joint sections GA1 and GA2 are flexible or elastically deformable to permit the pivoting or adjustment movement of the second blade element 12 operatively connected thereto.

In accordance with at least one possible exemplary embodiment, the solid body joint 14 is formed with the first and second side limb sections 14.1, 14.2, and the base limb section 14.3 connecting the side limb sections 14.1, 14.2, as one part or as an integral unit, and is manufactured from a metallic material.

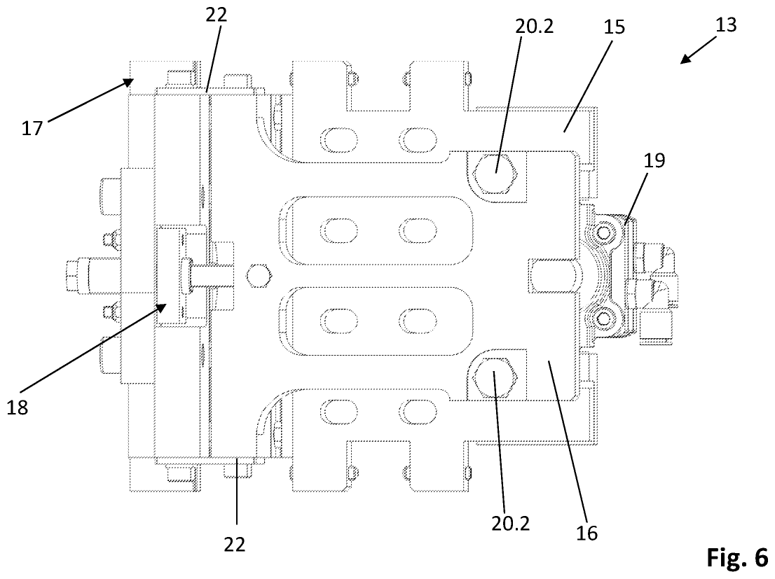

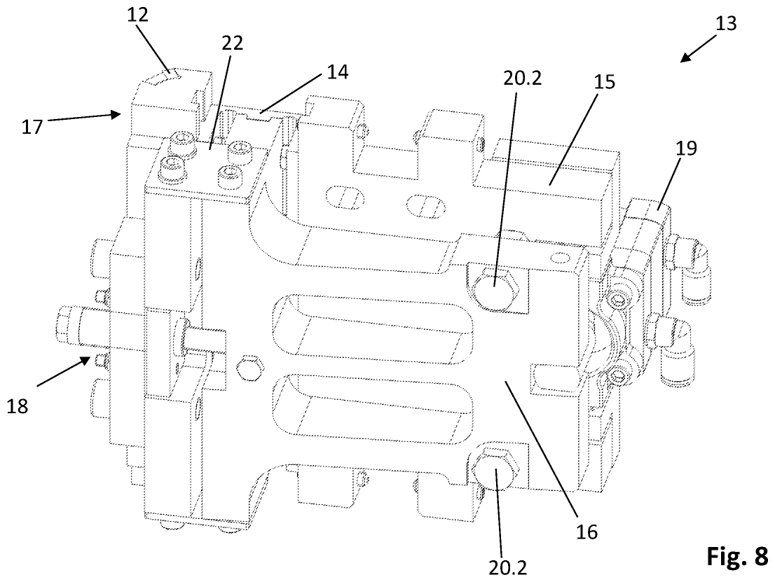

On the base limb section 14.3, the switching and adjusting device 13 comprises, in order to initiate the pivoting movement between the cutting position SP and the waiting position WP onto the second blade element 12, a switching lever element 16, extending essentially in an L-shape, as viewed from above, such as shown in FIGS. 5 and 8. The switching lever element 16 is arranged with its first side 16.1 formed on a short limb and connected or secured to the base limb section 14.3 in a detachable manner. The switching lever element 16 comprises a second side 16.2 that is formed at or on a longer limb. As can be best seen in FIGS. 6 and 8, a cut-out opening or recess or receiver 23 is formed at or in the second side 16.2, which cut-out opening 23 is configured to engage or interact with the switching device 19 in such a way that the switching lever element 16, at the initiation of an adjustment movement by the switching device 19, can be pivoted about the first joint section GA1. The pivoting movement on both sides is indicated by a double arrow E.

In addition, the switching element 16 comprises in the region of its free end section of the second side 16.2 a mechanical stop 20, by use of which the deflection of the switching lever element 16, i.e., the lift of the pivot movement between the waiting position WP and the cutting position SP, can be adjusted or is adjustable. By way of example, the stop 20 can be formed by a threaded spindle 20.1 screwed into the holder 15, at which in each case a stop element 20.2, 20.3 is provided, for example in the form of a nut, on opposing sides of the switching lever element 16.

In this situation, the stop element 20.2, provided at the threaded spindle 20.1 on the side facing away from the holder 15, forms a mechanical end stop for the maximum possible deflection of the switching lever element 16, in which the second blade element 12 is in its cutting position SP, i.e., is in working engagement with the first blade element 11 for the cutting of labels. The stop element 20.3, provided on the side of the threaded spindle 20.1 facing towards the holder 15, forms a mechanical end stop for the waiting position WP, in which the second blade element 12 is out of working engagement with the first blade element 11. By rotating the respective stop elements 20.2, 20.3 along the longitudinal axis of the threaded spindle 20.1, the corresponding end stop can be steplessly adjusted.

In addition to this, the switching and adjusting device 13 comprises, on its second side limb section 14.2, a blade holder 17, at which the second blade element 12 is held in such a way that it can be replaced. In at least one possible exemplary embodiment, the second blade element 12 is oriented to run parallel to the drum axis TA. In at least one possible exemplary embodiment, however, the blade holder 17, together with the second blade element 12 held by it, during a controlled pivot movement about the first joint axis GA1, pivots between the cutting position SP and the waiting position WP over the solid body joint 14, in a manner directly proportional to the deflection of the switching lever element 16.

In accordance with at least one possible exemplary embodiment, the blade holder 17 is arranged at the second side limb section 14.2 securely but detachably, such as being screwed to the second limb section 14.2. In accordance with at least one possible exemplary embodiment, the blade holder is disposed on or at the outer side of the second side limb section 14.2, opposite the switching element 16.

For this purpose, the relative positioning of the blade holder 17 provided at the second side limb section 14.2 in relation to the switching lever element 16 can be fixed securely by use of a locking plate 22. For example, for this purpose the locking plate 22 can be screwed both to the switching lever element 16 as well as to the blade holder 17.

Furthermore, by use of the second joint section GA2 formed at the switching and adjusting device 13, the cutting gap ST formed between the first blade element 11 and the second blade element 12 can be adjusted independently of the controlled pivot movement of the first joint section GA1.

In greater detail, for this purpose the blade holder 17, including the second blade element 12 held in it, is configured so as to pivot, in order thereby to adjust the blade gap by use of an adjustment device 18 provided at the blade holder 17, about the second joint section GA2 and relative to the switching lever element 16. The pivoting of the blade holder 17 by use of the adjustment device 18 about the second joint range GA2 formed between the second side limb section 14.2 and the base limb section 14.3 therefore takes place independently of the controlled pivot movement of the first joint section GA1.

For this purpose, the adjustment device 18 can accommodate forces in both directions of the pivot movement formed about the second joint section GA2. In greater detail, the adjustment device 18 can also comprise a threaded spindle 18.1 with a differential thread. In this situation, the threaded spindle 18.1 comprises two thread regions along its shaft, namely a first threaded region W1 and a second threaded region W2, which both exhibit the same thread direction but different thread pitches to one another. In this situation, the first thread region W1 of the threaded spindle 18.1 is accommodated in a counter-thread 17.1 of the blade holder 17, and the second thread region W2 is accommodated in a counter-thread 16.3 of the switching lever element 16.

For example, the first thread region W1 can exhibit a larger thread pitch than the second thread region W2 of the threaded spindle 18.1. When the threaded spindle 18.1 is tightened, the thread region W1 of the threaded spindle 18.1, with the larger thread pitch, slides in the counter-thread 17.1 of the blade holder 17. At the same time, however, the thread region W2, with the smaller pitch, moves in the counter-thread 16.3 of the switching lever element 16. Since a revolution of the threaded spindle 18.1 results in a shorter distance being covered in the threaded region with the smaller pitch W2, the two threaded regions W1, W2 of the threaded spindle 18.1 are tensioned against one another, i.e. in particular onto one another.

The adjustment of the blade gap by use of the adjustment device 18 takes place, for example, with the locking plate 22 unscrewed or loosened or unsecured, which, after the adjustment, is then screwed, via the screws 25, or fixed or secured in place onto the switching lever element 16 again, in order to fix the position of the blade holder 17.

The invention has been described heretofore on the basis of exemplary embodiments. It is understood that numerous modifications and derivations are possible without thereby departing from the underlying inventive concept of the invention.

The following is at least a partial list of components shown in the figures and their related reference numerals: labeling device 1; container 2; label 3; label material 3.1; supply roll 4; cutting unit 5; transfer drum 6; rotor 7; conveyor roller 8; conveyor roller 9; cutting drum 10; drum circumferential surface 10.1; first blade element 11; first cutting edge 11.1; second blade element 12; second cutting edge 12.1; switching and adjusting device 13; solid body joint 14; first side limb section 14.1; second side limb section 14.2; base limb section 14.3; holder 15; switching lever element 16; first side 16.1; second side 16.2; counter-thread 16.3; blade holder 17; counter-thread 17.1; adjustment device 18; threaded spindle 18.1; switching device 19; stop 20; threaded spindle 20.1; stop element 20.2; stop element 20.3; housing 21; locking plate 22; receiver 23; screw 25; direction of rotation of rotor A; direction of rotation of transfer drum B; direction of rotation of cutting device C; adjustment movement of cutting device D; pivot movement about the first joint section E; first surface FL1; second surface FL2; plane F; first joint section GA1; second joint section GA2; cutting position SP; cutting gap ST; waiting position WP; first thread section W1; second thread section W2; and drum axis TA.

At least one possible exemplary embodiment of the present application relates to a cutting unit for a labeling device of a labeling machine, comprising a cutting drum 10 which can be driven such as to rotate about a drum axis TA, with at least one first blade element 11 provided at a drum periphery 10.1, with at least one cutting edge 11.1, which in order to cut a label 3 interacts with at least one second cutting edge 12.1 of a second blade element 12 provided at a switching and adjusting device 13, with the formation of a cutting gap ST, wherein the second blade element 12 exhibits a second hardness at least in the region of its second cutting edge 12.1, which is configured as greater than a first hardness at least in the region of the first cutting edge 11.1 of the first blade element 11, and wherein the first cutting edge 11.1 of the first blade element 11 can be produced by the removal of material at the second cutting edge 12.1 of the second blade element 12 with the greater second hardness, wherein the first blade element 11 is formed at least in the region of its first cutting edge 11.1 from a steel from the group of the cold-work steels, and the second blade element 12 is formed at least in the region of its second cutting edge 12.1 from a carbide metal.

At least one other possible exemplary embodiment of the present application relates to the cutting unit, wherein the first blade element 11 is formed, in particular manufactured, from a full material of a steel from the group of the cold-work steels and/or the second blade element 12 is formed, in particular manufactured, from a full material of a carbide metal.

At least one other possible exemplary embodiment of the present application relates to the cutting unit, wherein the second blade element 12 is manufactured at least in the region of its second cutting edge 12.1 from a carbide steel or tool steel or ceramic.

At least one other possible exemplary embodiment of the present application relates to the cutting unit, wherein the steel from the group of the cold-work steels is an unalloyed or alloyed cold-work steel.

At least one other possible exemplary embodiment of the present application relates to the cutting unit, wherein the steel from the group of the cold-work steels exhibits a first hardness according to Rockwell from 55 HRC to 59 HRC.

At least one other possible exemplary embodiment of the present application relates to the cutting unit, wherein the steel from the group of cold-work steels is formed as a cold-work steel with the material number 1.2550, or as a cold-work steel with the material number 1.2379, or as a cold-work steel with the material number 1.4034.

At least one other possible exemplary embodiment of the present application relates to the cutting unit, wherein the steel from the group of cold-work steels is formed as a cold-work steel Vanadis 10 or Viking, with a chemical composition of C 0.5%, Si 1%, Mn 0.5%, Cr 8%, Mo 1.5%, and V 0.5%.

At least one other possible exemplary embodiment of the present application relates to the cutting unit, wherein the second blade element 12 is manufactured at least in the region of its second cutting edge 12.1 from a carbide metal, which is formed as a metal matrix composite material.

At least one other possible exemplary embodiment of the present application relates to the cutting unit, wherein the second blade element 12 is manufactured from a carbide metal, which is formed as a tungsten carbide-cobalt carbide metal type WC—Co and/or as a carbide metal type for steel working WC—Ti,Ta,NbC—Co and/or as a Cermet carbide metal type.

At least one other possible exemplary embodiment of the present application relates to the cutting unit, wherein the carbide metal of the second blade element 12 exhibits a second hardness according to Vickers of 1150 HV30 and/or a fracture toughness according to Palmqvist of 15.5 MN/mm.

At least one other possible exemplary embodiment of the present application relates to the cutting unit, wherein the counter-blade 12 can be pivoted over a first joint section GA1, formed at the switching and adjusting device 13, between a cutting position SP and a waiting position WP, in such a way that the counter-blade 12 in the cutting position SP is in working engagement with the rotating first blade 11, and in the waiting position WP is out of working engagement, and that, by way of a second joint section GA2 formed at the switching and adjusting device 13, the blade gap formed in the cutting position SP between the first blade 11 and the counter-blade 12 can be adjusted independently of the controlled pivot movement of the first joint section GA1.

At least one other possible exemplary embodiment of the present application relates to the cutting unit, wherein the switching and adjusting device 13 is configured such as to pivot the first joint section GA1 between the cutting position SP and the waiting position WP in a controlled manner, in such a way that, in the event of isolated gaps occurring in the bottle stream of the labeling device 1, no label 3 will be cut for at least this empty unoccupied container handling position at the rotor 7.

At least one other possible exemplary embodiment of the present application relates to the cutting unit, wherein the switching and adjusting device 13 comprises a solid body joint 14 with a U-profile shape, at which the first and second joint sections GA1, GA2 are formed.

At least one other possible exemplary embodiment of the present application relates to the cutting unit, wherein the solid body joint 14 comprises a first side limb section 14.1, a second side limb section 14.2 oriented essentially parallel to the first side limb section 14.1, and a base limb section 14.3 connecting the two side limb sections 14.1, 14.2 at a free end.

At least one other possible exemplary embodiment of the present application relates to the cutting unit, wherein the first joint section GA1 at the solid body joint 14 is formed in the transition region between the first side limb section 14.1 and the base limb section 14.3, and the second joint section GA2 is formed in the transition section between the second side limb section 14.2 and the base limb section 14.3, and that the solid body joint 14 is configured as elastically deformable at least in its respective joint section GA1, GA2.

At least one other possible exemplary embodiment of the present application relates to the cutting unit, wherein the solid body joint 14 is configured as being of one part, and in particular as of one piece.

At least one other possible exemplary embodiment of the present application relates to the cutting unit, wherein the switching and adjusting device 13 is secured by use of a holder 15, secured to the first side limb section 14.1, in a permanent position at a housing 21 of the cutting unit 5.

At least one other possible exemplary embodiment of the present application relates to the cutting unit, wherein the switching and adjusting device 13 comprises an essentially L-shaped extending switching lever element 16, which, in order to initiate a pivot movement between the cutting position SP and the waiting position WP onto the counter-blade 12, is connected by a first side 16.1 to the base limb section 14.3, and by a second side 16.2 interacts directly or indirectly with a switching device 19, in such a way that the switching lever element 16, at the initiation of a setting movement by use of the switching device 19, can be pivoted in a controlled manner about the first joint region GA1.

At least one other possible exemplary embodiment of the present application relates to the cutting unit, wherein the switching lever element 16 comprises in the region of its free end section of the second side 16.2 a mechanical stop 20, by use of which the deflection of the switching lever element 16 between the waiting position WP and the cutting position SP is adjustable.

At least one other possible exemplary embodiment of the present application relates to the cutting unit, wherein the switching and adjusting device 13 comprises on its second side limb section 14.2 of the solid body joint 14 a blade holder 17, at which the counter-blade 12 is held in such a way that the counter-blade 12 is configured, at a controlled pivot movement about the first joint region GA1, such as to pivot with this directly proportionally to the deflection of the switching element lever 16.

At least one other possible exemplary embodiment of the present application relates to the cutting unit, wherein the relative positioning of the blade holder 17 provided at the second side limb section 14.2 can be fixed in a secure position to the switching lever element 16 by use of a locking plate 22.

At least one other possible exemplary embodiment of the present application relates to the cutting unit, wherein the blade holder 17, including the counter-blade 12 held in it, in order to adjust and set the blade gap by use of an adjustment device 18 provided at the blade holder 17, is configured such as to pivot about the second joint section GA2 relative to the switching lever element 16.

At least one other possible exemplary embodiment of the present application relates to the cutting unit, wherein the adjustment device 18 comprises a threaded spindle 18.1 with a differential thread, wherein the threaded spindle 18.1 provides along its shaft at least one first thread region W1 and a second thread region W2, which both exhibit the same thread direction but with different thread pitches to one another, wherein the first thread region W1 of the threaded spindle 18.1 is accommodated in a counter-thread 17.1 of the blade holder 17 and the second thread region W2 is accommodated in a counter-thread 16.3 of the switching lever element 16.

At least one possible exemplary embodiment of the present application relates to a labeling device for a labeling machine for the labeling of containers 2 with a roll-fed label, comprising at least one cutting unit 5, wherein the cutting unit 5 is configured in accordance with any one of possible exemplary embodiments disclosed herein.

At least one possible exemplary embodiment of the present application relates to a beverage container handling machine, such as a beverage container filling machine or a beverage container closing machine, configured to handle beverage bottles, cans, and similar containers, which containers are configured to hold or contain a beverage, such as water, soft drinks, beer, wine, and juices, or a similar product for transport and consumption by consumers of beverages and similar products, said beverage container handling machine comprising: a stationary support arrangement being configured and disposed to support and house components of said beverage container handling machine; a rotor being supported by said stationary support arrangement and being configured to be rotatable about an axis of rotation to move a plurality of beverage containers along a path of movement between a beverage container input region and a beverage container output region of said rotor; said rotor comprising a plurality of beverage container transport positions; said beverage container transport positions being disposed about the periphery or around the outer perimeter of said rotor; each of said beverage container transport positions being configured to hold a beverage container or similar container upon said rotor being rotated about its axis of rotation to permit said rotor to move a plurality of beverage containers along the path of movement between said beverage container input region and said beverage container output region of said rotor; at least one beverage container handling device being configured to handle a beverage container or similar container upon said rotor being rotated about its axis of rotation to permit handling of said beverage containers upon the beverage containers being moved along the path of movement between said beverage container input region and said beverage container output region; said at least one beverage container handling device being disposed: on said rotor to be movable with said rotor, or on a portion of said stationary support arrangement disposed adjacent said rotor, or partially on said rotor to be movable with said rotor and partially on a portion of said stationary support arrangement disposed adjacent said rotor; said at least one beverage container handling device comprising a beverage container labeling device being configured and disposed to apply beverage container labels to beverage containers; said at least one beverage container labeling device comprising a supply roll comprising a continuous, wound strip of beverage container label material comprising a plurality of individual beverage container labels; said at least one beverage container labeling device comprising a conveyor roller arrangement being configured and disposed to unwind and transport said strip of beverage container label material; said at least one beverage container labeling device comprising a beverage container label cutting arrangement being configured to cut off an individual beverage container label from said unwound strip of beverage container label material; and said beverage container label cutting arrangement comprising: a drum being configured and disposed to rotate about a drum axis; a first cutting element being disposed on a peripheral portion of said drum; said first cutting element comprising a first cutting edge; a switching and adjusting arrangement being disposed adjacent said drum; a second cutting element being disposed on said switching and adjusting arrangement; said second cutting element comprising a second cutting edge; said drum being configured to be rotated to move said first cutting edge past said second cutting edge to permit said first cutting edge and said second cutting edge to interact with one another to cut a beverage container label material; said switching and adjusting arrangement comprising a first joint section and a second joint section; said first joint section being adjustable to permit pivoting movement of said second cutting element operatively connected to said first joint section to move said second cutting element between an engaged, cutting position, in which said second cutting element is disposed to interact with said first cutting element to cut beverage container label material upon said first cutting element being moved past said second cutting element, and a disengaged, waiting position, in which said second cutting element is disposed to not interact with said first cutting element to not cut beverage container label material upon said first cutting element being moved past said second cutting element; and said second joint section being adjustable, independently of said first joint section, to permit pivoting movement of said second cutting element operatively connected to said second joint section to adjust the position of said second cutting element with respect to said switching and adjusting arrangement, and thereby adjust a cutting distance between said first cutting element and said second cutting element, which cutting distance being the distance between said first cutting element and said second cutting element upon said first cutting element and said cutting element being in said engaged, cutting position.

At least one other possible exemplary embodiment of the present application relates to the beverage container handling machine, wherein: said switching and adjusting device is configured to be switched to pivot said first joint section into said disengaged, waiting position upon the occurrence of an unoccupied beverage container transport position due to an absence of a beverage container in a stream of beverage containers to be labeled, such that no label will be cut upon the unoccupied beverage container transport position being in a labeling position at said beverage container labeling device; and said switching and adjusting device comprises a solid body joint having a U-shaped profile, which solid body joint comprises said first joint section and said second joint section.

At least one possible exemplary embodiment of the present application relates to a method of handling beverage containers using a beverage container handling machine, such as a beverage container filling machine or a beverage container closing machine, configured to handle beverage bottles, cans, and similar containers, which containers are configured to hold or contain a beverage, such as water, soft drinks, beer, wine, and juices, or a similar product for transport and consumption by consumers of beverages and similar products, said method comprising the steps of: rotating said rotor about the axis of rotation to move a plurality of beverage containers along a path of movement between said beverage container input region and said beverage container output region of said rotor; holding beverage containers of similar containers at said beverage container transport positions upon said rotor being rotated; unwinding said supply roll of beverage container label material and transporting said strip of beverage container label material using said conveyor roller arrangement to said beverage container label cutting arrangement; cutting off an individual beverage container label from said unwound strip of beverage container label material upon a beverage container being moved into a labeling position adjacent said beverage container labeling device by rotating said drum and moving said first cutting edge past said second cutting edge and said first cutting edge and said second cutting edge interacting with one another; adjusting said first joint section and pivotably moving said second cutting element from the engaged, cutting position to the disengaged, waiting position to prevent cutting off of at least one other individual beverage container label; and adjusting said second joint section, independently of said first joint section, and pivotably moving said second cutting element and adjusting the position of said second cutting element with respect to said switching and adjusting arrangement, and thereby adjusting the cutting distance between said first cutting element and said second cutting element.

At least one other possible exemplary embodiment of the present application relates to the method of handling beverage containers using a beverage container handling machine, wherein: said step of adjusting said first joint section comprises switching said switching and adjusting device and pivoting said first joint section into said disengaged, waiting position upon the occurrence of an unoccupied beverage container transport position due to an absence of a beverage container in a stream of beverage containers to be labeled, such that no label will be cut upon the unoccupied beverage container transport position being in the labeling position at said beverage container labeling device; and said switching and adjusting device comprises a solid body joint having a U-shaped profile, which solid body joint comprises said first joint section and said second joint section.

At least one possible exemplary embodiment of the present application relates to, in a beverage container handling machine, such as a beverage container filling machine or a beverage container closing machine, configured to handle beverage bottles, cans, and similar containers, which containers are configured to hold or contain a beverage, such as water, soft drinks, beer, wine, and juices, or a similar product for transport and consumption by consumers of beverages and similar products, a beverage container label cutting arrangement configured to cut off an individual beverage container label from an unwound strip of beverage container label material, said beverage container label cutting arrangement comprising: a drum being configured and disposed to rotate about a drum axis; a first cutting element being disposed on a peripheral portion of said drum; said first cutting element comprising a first cutting edge; a switching and adjusting arrangement being disposed adjacent said drum; a second cutting element being disposed on said switching and adjusting arrangement; said second cutting element comprising a second cutting edge; said drum being configured to be rotated to move said first cutting edge past said second cutting edge to permit said first cutting edge and said second cutting edge to interact with one another to: (A) cut a beverage container label material upon beverage container label material being disposed at said second cutting edge, and (B) form or sharpen said first cutting edge by removal of material by said second cutting edge upon performance of a forming or sharpening of said first cutting edge; and said first cutting element comprising, at least at said first cutting edge, a steel having a first hardness and being from the group of the cold-work steels, and said second cutting element comprising, at least at said second cutting edge, a carbide metal having a second hardness, wherein said second hardness being greater than said first hardness.

At least one other possible exemplary embodiment of the present application relates to the beverage container label cutting arrangement, wherein at least one of: (C) said first cutting element is formed or manufactured substantially solely or essentially solely from said steel, and (D) said second cutting element is formed or manufactured substantially solely or essentially solely from said carbide metal, and (E) said second cutting element is formed or manufactured, at least in the region of said second cutting edge, from a carbide steel or tool steel or ceramic.

At least one other possible exemplary embodiment of the present application relates to the beverage container label cutting arrangement, wherein said steel is an unalloyed or alloyed cold-work steel and exhibits a first hardness according to the hardness on Rockwell scale C of 55 to 59.

At least one other possible exemplary embodiment of the present application relates to the beverage container label cutting arrangement, wherein said steel is a cold-work steel having the material number 1.2550, 1.2379, or 1.4034 according to the European Norm standard, and/or said steel is Vanadis® 10 or Viking comprising C 0.5%, Si 1%, Mn 0.5%, Cr 8%, Mo 1.5%, and V 0.5%.

At least one other possible exemplary embodiment of the present application relates to the beverage container label cutting arrangement, wherein: said carbide metal comprises a metal matrix composite material, or comprises at least one of: a tungsten carbide-cobalt carbide metal type (WC—Co), a carbide metal type for steel working (WC—(Ti,Ta,Nb)C—Co), and a Cermet carbide metal type; and said second hardness has a hardness of 1150 according to Vickers and/or a fracture toughness according to Palmqvist of 15.5 MN/mm.

At least one possible exemplary embodiment of the present application relates to, in a beverage container handling machine, such as a beverage container filling machine or a beverage container closing machine, configured to handle beverage bottles, cans, and similar containers, which containers are configured to hold or contain a beverage, such as water, soft drinks, beer, wine, and juices, or a similar product for transport and consumption by consumers of beverages and similar products, a beverage container label cutting arrangement configured to cut off an individual beverage container label from an unwound strip of beverage container label material, said beverage container label cutting arrangement comprising: a drum being configured and disposed to rotate about a drum axis; a first cutting element being disposed on a peripheral portion of said drum; said first cutting element comprising a first cutting edge; a switching and adjusting arrangement being disposed adjacent said drum; a second cutting element being disposed on said switching and adjusting arrangement; said second cutting element comprising a second cutting edge; said drum being configured to be rotated to move said first cutting edge past said second cutting edge to permit said first cutting edge and said second cutting edge to interact with one another to cut a beverage container label material upon beverage container label material being disposed at said second cutting edge; said switching and adjusting arrangement comprising a first joint section and a second joint section; said first joint section being adjustable to permit pivoting movement of said second cutting element operatively connected to said first joint section to move said second cutting element between an engaged, cutting position, in which said second cutting element is disposed to interact with said first cutting element to cut beverage container label material upon said first cutting element being moved past said second cutting element, and a disengaged, waiting position, in which said second cutting element is disposed to not interact with said first cutting element to not cut beverage container label material upon said first cutting element being moved past said second cutting element; and said second joint section being adjustable, independently of said first joint section, to permit pivoting movement of said second cutting element operatively connected to said second joint section to adjust the position of said second cutting element with respect to said switching and adjusting arrangement, and thereby adjust a cutting distance between said first cutting element and said second cutting element, which cutting distance being the distance between said first cutting element and said second cutting element upon said first cutting element and said second cutting element being in said engaged, cutting position.

At least one other possible exemplary embodiment of the present application relates to the beverage container label cutting arrangement, wherein said switching and adjusting device is configured to be switched to pivot said first joint section into said disengaged, waiting position upon the occurrence of an unoccupied beverage container transport position due to an absence of a beverage container in a stream of beverage containers to be labeled, such that no label will be cut upon the unoccupied beverage container transport position being in a labeling position at said beverage container labeling device.

At least one other possible exemplary embodiment of the present application relates to the beverage container label cutting arrangement, wherein said switching and adjusting device comprises a solid body joint having a U-shaped profile, which said solid body joint comprises said first joint section and said second joint section.

At least one other possible exemplary embodiment of the present application relates to the beverage container label cutting arrangement, wherein said solid body joint comprises a first side limb section, a second side limb section oriented essentially parallel to said first side limb section, and a base limb section disposed to connect said first side limb section and said second side limb section to form said U-shaped profile.

At least one other possible exemplary embodiment of the present application relates to the beverage container label cutting arrangement, wherein: said first joint section is formed at the transition between said first side limb section and said base limb section; said second joint section is formed at the transition between said second side limb section and said base limb section; and said solid body joint is elastically deformable at least at said first and second joint sections.

At least one other possible exemplary embodiment of the present application relates to the beverage container label cutting arrangement, wherein: said solid body joint comprises an integral or one-piece structure; the beverage container label cutting arrangement further comprises a stationary housing; and said switching and adjusting device is secured to said housing via said first side limb section, which first side limb section is held in a fixed position on said housing.

At least one other possible exemplary embodiment of the present application relates to the beverage container label cutting arrangement, wherein: said switching and adjusting device comprises an essentially L-shaped switching lever element, which switching lever element comprises a first elongated portion and a second elongated portion smaller than said first elongated portion; said switching and adjusting device comprises a switching device; said second elongated portion is connected to said base limb section; said first elongated portion is operatively connected to said switching device; and said switching device is configured to be activated to pivotably move said switching lever element to thereby elastically deform said solid body joint at said first joint section and pivotably move said base limb section to move said second cutting element between said cutting position and said waiting position; and the beverage container label cutting arrangement comprises a mechanical stop arrangement configured to restrict the range of adjusting movement of said first elongated portion to determine said cutting position and said waiting position of said second cutting element, which mechanical stop arrangement is adjustable to permit adjustment of said cutting position and said waiting position of said second cutting element.

At least one other possible exemplary embodiment of the present application relates to the beverage container label cutting arrangement, wherein: said switching and adjusting device comprises a cutting element holder configured to securely hold said second cutting element; said switching and adjusting device comprises a locking structure configured and disposed to connect said cutting element holder to said switching lever element such that, upon pivoting movement of said base limb section about said first joint region, said second cutting element is pivoted with said switching element lever; said switching and adjusting device comprises an adjustment device configured and disposed to move said cutting element holder relative to said switching lever element, and thereby pivot said second side limb section about said second joint section, to adjust said cutting distance; said adjustment device comprises a threaded spindle comprising a differential thread; said threaded spindle comprises, along its shaft, a first thread region and a second thread region, which both exhibit the same thread direction but with different thread pitches to one another; said first thread region of the threaded spindle is accommodated in a counter-thread of said cutting element holder; and said second thread region is accommodated in a counter-thread of said switching lever element.

At least one other possible exemplary embodiment of the present application relates to the beverage container label cutting arrangement, wherein said first cutting element comprising, at least at said first cutting edge, a steel having a first hardness and being from the group of the cold-work steels, and said second cutting element comprising, at least at said second cutting edge, a carbide metal having a second hardness, wherein said second hardness being greater than said first hardness.

At least one possible exemplary embodiment of the present application relates to a method of using the beverage container label cutting arrangement configured to cut off an individual beverage container label from an unwound strip of beverage container label material, said method comprising the steps of: cutting off an individual beverage container label from an unwound strip of beverage container label material upon a beverage container being moved into a labeling position adjacent said beverage container labeling device by rotating said drum and moving said first cutting edge past said second cutting edge and said first cutting edge and said second cutting edge interacting with one another; and at least one of: adjusting said first joint section and pivotably moving said second cutting element from the engaged, cutting position to the disengaged, waiting position to prevent cutting off of at least one other individual beverage container label; and adjusting said second joint section, independently of said first joint section, and pivotably moving said second cutting element and adjusting the position of said second cutting element with respect to said switching and adjusting arrangement, and thereby adjusting the cutting distance between said first cutting element and said second cutting element.

At least one other possible exemplary embodiment of the present application relates to the method of using the beverage container label cutting arrangement, wherein: said switching and adjusting device comprises a solid body joint having a U-shaped profile, which solid body joint comprises said first joint section and said second joint section; said solid body joint comprises a first side limb section, a second side limb section oriented essentially parallel to said first side limb section, and a base limb section disposed to connect said first side limb section and said second side limb section to form said U-shaped profile; said first joint section is formed at the transition between said first side limb section and said base limb section; said second joint section is formed at the transition between said second side limb section and said base limb section; and said solid body joint is elastically deformable at least at said first and second joint sections.

Any numerical values disclosed herein, if any, should be understood as disclosing all approximate values within plus or minus ten percent of the numerical value. Any ranges of numerical values disclosed herein, if any, should be understood as disclosing all individual values within the range of values, including whole numbers, tenths of numbers, or hundredths of numbers.

The entirety of the appended drawings, including all dimensions, proportions, and/or shapes disclosed thereby or reasonably understood therefrom, are hereby incorporated by reference.

All of the patents, patent applications, patent publications, and other documents cited herein, are hereby incorporated by reference as if set forth in their entirety herein.

The corresponding foreign or international patent applications, as originally filed and as published, from which the present application claims the benefit of priority, are hereby incorporated by reference as if set forth in their entirety herein, as follows: PCT/EP2020/067288 and DE102019118271.9.

The following patents, patent applications, patent publications, and other documents cited in the corresponding foreign or international patent applications listed in the preceding paragraph are hereby incorporated by reference as if set forth in their entirety herein, as follows: DE102007057409; DE2628728; U.S. Pat. No. 4,041,816; DE29824233; DE102005038024; WO2010051943; WO2008049593; WO9710953; EP2974834; and DE202005002793.

An example of a cutting drum and components thereof or related thereto, parts of which may be used or adapted for use in at least one possible exemplary embodiment, are disclosed in DE202005002793, which is incorporated by reference herein.

Although the invention has been described in detail for the purpose of illustration of any embodiments disclosed herein, including the most practical or preferred embodiments at the time of filing of this application, it is to be understood that such detail is solely for that purpose and that the invention is not limited to such embodiments, but, on the contrary, is intended to cover modifications and equivalent arrangements that are within the spirit and scope of the present application, including the specification and the claims as originally filed, as amended, or as issued. For example, it is to be understood that the present invention contemplates that, to the extent possible, one or more features or components of any disclosed embodiment can be combined with one or more features or components of any other disclosed embodiment.

What is claimed is:

1. A beverage container handling machine, such as a beverage container filling machine or a beverage container closing machine, configured to handle beverage bottles, cans, and similar containers, which containers are configured to hold or contain a beverage, such as water, soft drinks, beer, wine, and juices, or a similar product for transport and consumption by consumers of beverages and similar products, said beverage container handling machine comprising:
a stationary support arrangement being configured and disposed to support and house components of said beverage container handling machine;
a rotor being supported by said stationary support arrangement and being configured to be rotatable about an axis of rotation to move a plurality of beverage containers along a path of movement between a beverage container input region and a beverage container output region of said rotor;
said rotor comprising a plurality of beverage container transport positions;
said beverage container transport positions being disposed about the periphery or around the outer perimeter of said rotor;
each of said beverage container transport positions being configured to hold a beverage container or similar container upon said rotor being rotated about its axis of rotation to permit said rotor to move a plurality of beverage containers along the path of movement between said beverage container input region and said beverage container output region of said rotor;
at least one beverage container handling device being configured to handle a beverage container or similar container upon said rotor being rotated about its axis of rotation to permit handling of said beverage containers upon the beverage containers being moved along the path of movement between said beverage container input region and said beverage container output region;
said at least one beverage container handling device being disposed:
on said rotor to be movable with said rotor, or
on a portion of said stationary support arrangement disposed adjacent said rotor, or
partially on said rotor to be movable with said rotor and partially on a portion of said stationary support arrangement disposed adjacent said rotor;
said at least one beverage container handling device comprising a beverage container labeling device being configured and disposed to apply beverage container labels to beverage containers;
said at least one beverage container labeling device comprising a supply roll comprising a continuous, wound strip of beverage container label material comprising a plurality of individual beverage container labels;
said at least one beverage container labeling device comprising a conveyor roller arrangement being configured and disposed to unwind and transport said strip of beverage container label material;
said at least one beverage container labeling device comprising a beverage container label cutting arrangement being configured to cut off an individual beverage container label from said unwound strip of beverage container label material; and
said beverage container label cutting arrangement comprising:
a drum being configured and disposed to rotate about a drum axis;
a first cutting element being disposed on a peripheral portion of said drum;
said first cutting element comprising a first cutting edge;
a switching and adjusting arrangement being disposed adjacent said drum;
a second cutting element being disposed on said switching and adjusting arrangement;
said second cutting element comprising a second cutting edge;
said drum being configured to be rotated to move said first cutting edge past said second cutting edge to permit said first cutting edge and said second cutting edge to interact with one another to cut a beverage container label material;
said switching and adjusting arrangement comprising a first joint section and a second joint section;
said first joint section being adjustable to permit pivoting movement of said second cutting element operatively connected to said first joint section to move said second cutting element between an engaged, cutting position, in which said second cutting element is disposed to interact with said first cutting element to cut beverage container label material upon said first cutting element being moved past said second cutting element, and a disengaged, waiting position, in which said second cutting element is disposed to not interact with said first cutting element to not cut beverage container label material upon said first cutting element being moved past said second cutting element; and
said second joint section being adjustable, independently of said first joint section, to permit pivoting movement of said second cutting element operatively connected to said second joint section to adjust the position of said second cutting element with respect to said switching and adjusting arrangement, and thereby adjust a cutting distance between said first cutting element and said second cutting element, which cutting distance being the distance between said first cutting element and said second cutting element upon said first cutting element and said cutting element being in said engaged, cutting position.

2. The beverage container handling machine according to claim 1, wherein:
said switching and adjusting device is configured to be switched to pivot said first joint section into said disengaged, waiting position upon the occurrence of an unoccupied beverage container transport position due to an absence of a beverage container in a stream of beverage containers to be labeled, such that no label will be cut upon the unoccupied beverage container transport position being in a labeling position at said beverage container labeling device; and
said switching and adjusting device comprises a solid body joint having a U-shaped profile, which solid body joint comprises said first joint section and said second joint section.

3. A method of handling beverage containers using a beverage container handling machine, such as a beverage container filling machine or a beverage container closing machine, configured to handle beverage bottles, cans, and similar containers, which containers are configured to hold or contain a beverage, such as water, soft drinks, beer, wine, and juices, or a similar product for transport and consumption by consumers of beverages and similar products, according to claim 1, said method comprising the steps of:
rotating said rotor about the axis of rotation to move a plurality of beverage containers along a path of movement between said beverage container input region and said beverage container output region of said rotor;
holding beverage containers of similar containers at said beverage container transport positions upon said rotor being rotated;
unwinding said supply roll of beverage container label material and transporting said strip of beverage container label material using said conveyor roller arrangement to said beverage container label cutting arrangement;
cutting off an individual beverage container label from said unwound strip of beverage container label material upon a beverage container being moved into a labeling position adjacent said beverage container labeling device by rotating said drum and moving said first cutting edge past said second cutting edge and said first cutting edge and said second cutting edge interacting with one another;
adjusting said first joint section and pivotably moving said second cutting element from the engaged, cutting position to the disengaged, waiting position to prevent cutting off of at least one other individual beverage container label; and
adjusting said second joint section, independently of said first joint section, and pivotably moving said second cutting element and adjusting the position of said second cutting element with respect to said switching and adjusting arrangement, and thereby adjusting the cutting distance between said first cutting element and said second cutting element.

4. The method of handling beverage containers using a beverage container handling machine according to claim 3, wherein:
said step of adjusting said first joint section comprises switching said switching and adjusting device and pivoting said first joint section into said disengaged, waiting position upon the occurrence of an unoccupied beverage container transport position due to an absence of a beverage container in a stream of beverage containers to be labeled, such that no label will be cut upon the unoccupied beverage container transport position being in the labeling position at said beverage container labeling device; and
said switching and adjusting device comprises a solid body joint having a U-shaped profile, which solid body joint comprises said first joint section and said second joint section.

5. In a beverage container handling machine, such as a beverage container filling machine or a beverage container closing machine, configured to handle beverage bottles, cans, and similar containers, which containers are configured to hold or contain a beverage, such as water, soft drinks, beer, wine, and juices, or a similar product for transport and consumption by consumers of beverages and similar products, a beverage container label cutting arrangement configured to cut off an individual beverage container label from an unwound strip of beverage container label material, said beverage container label cutting arrangement comprising:
a drum being configured and disposed to rotate about a drum axis;
a first cutting element being disposed on a peripheral portion of said drum;
said first cutting element comprising a first cutting edge;
a switching and adjusting arrangement being disposed adjacent said drum;
a second cutting element being disposed on said switching and adjusting arrangement;
said second cutting element comprising a second cutting edge;
said drum being configured to be rotated to move said first cutting edge past said second cutting edge to permit said first cutting edge and said second cutting edge to interact with one another to: (A) cut a beverage container label material upon beverage container label material being disposed at said second cutting edge, and (B) form or sharpen said first cutting edge by removal of material by said second cutting edge upon performance of a forming or sharpening of said first cutting edge; and
said first cutting element comprising, at least at said first cutting edge, a steel having a first hardness and being from the group of the cold-work steels, and said second cutting element comprising, at least at said second cutting edge, a carbide metal having a second hardness, wherein said second hardness being greater than said first hardness.

6. The beverage container label cutting arrangement according to claim 5, wherein at least one of: (C) said first cutting element is formed or manufactured substantially solely or essentially solely from said steel, and (D) said second cutting element is formed or manufactured substantially solely or essentially solely from said carbide metal, and (E) said second cutting element is formed or manufactured, at least in the region of said second cutting edge, from a carbide steel or tool steel or ceramic.

7. The beverage container label cutting arrangement according to claim 6, wherein said steel is an unalloyed or alloyed cold-work steel and exhibits a first hardness according to the hardness on Rockwell scale C of 55 to 59.

8. The beverage container label cutting arrangement according to claim 7, wherein said steel is a cold-work steel having the material number 1.2550, 1.2379, or 1.4034 according to the European Norm standard, and/or said steel is Vanadis® 10 or Viking comprising C 0.5%, Si 1%, Mn 0.5%, Cr 8%, Mo 1.5%, and V 0.5%.

9. The beverage container label cutting arrangement according to claim 8, wherein:
said carbide metal comprises a metal matrix composite material, or comprises at least one of: a tungsten carbide-cobalt carbide metal type (WC—Co), a carbide metal type for steel working (WC—(Ti,Ta,Nb)C—Co), and a Cermet carbide metal type; and
said second hardness has a hardness of 1150 according to Vickers and/or a fracture toughness according to Palmqvist of 15.5 MN/mm.

10. In a beverage container handling machine, such as a beverage container filling machine or a beverage container closing machine, configured to handle beverage bottles, cans, and similar containers, which containers are configured to hold or contain a beverage, such as water, soft drinks, beer, wine, and juices, or a similar product for transport and consumption by consumers of beverages and similar products, a beverage container label cutting arrangement configured to cut off an individual beverage container label from an unwound strip of beverage container label material, said beverage container label cutting arrangement comprising:
a drum being configured and disposed to rotate about a drum axis;
a first cutting element being disposed on a peripheral portion of said drum;
said first cutting element comprising a first cutting edge;
a switching and adjusting arrangement being disposed adjacent said drum;
a second cutting element being disposed on said switching and adjusting arrangement;
said second cutting element comprising a second cutting edge;
said drum being configured to be rotated to move said first cutting edge past said second cutting edge to permit said first cutting edge and said second cutting edge to interact with one another to cut a beverage container label material upon beverage container label material being disposed at said second cutting edge;
said switching and adjusting arrangement comprising a first joint section and a second joint section;
said first joint section being adjustable to permit pivoting movement of said second cutting element operatively connected to said first joint section to move said second cutting element between an engaged, cutting position, in which said second cutting element is disposed to interact with said first cutting element to cut beverage container label material upon said first cutting element being moved past said second cutting element, and a disengaged, waiting position, in which said second cutting element is disposed to not interact with said first cutting element to not cut beverage container label material upon said first cutting element being moved past said second cutting element; and
said second joint section being adjustable, independently of said first joint section, to permit pivoting movement of said second cutting element operatively connected to said second joint section to adjust the position of said second cutting element with respect to said switching and adjusting arrangement, and thereby adjust a cutting distance between said first cutting element and said second cutting element, which cutting distance being the distance between said first cutting element and said second cutting element upon said first cutting element and said second cutting element being in said engaged, cutting position.

11. The beverage container label cutting arrangement according to claim 10, wherein said switching and adjusting device is configured to be switched to pivot said first joint section into said disengaged, waiting position upon the occurrence of an unoccupied beverage container transport position due to an absence of a beverage container in a stream of beverage containers to be labeled, such that no label will be cut upon the unoccupied beverage container transport position being in a labeling position at said beverage container labeling device.

12. The beverage container label cutting arrangement according to claim 11, wherein said switching and adjusting device comprises a solid body joint having a U-shaped profile, which said solid body joint comprises said first joint section and said second joint section.

13. The beverage container label cutting arrangement according to claim 12, wherein said solid body joint comprises a first side limb section, a second side limb section oriented essentially parallel to said first side limb section, and a base limb section disposed to connect said first side limb section and said second side limb section to form said U-shaped profile.

14. The beverage container label cutting arrangement according to claim 13, wherein:
said first joint section is formed at the transition between said first side limb section and said base limb section;
said second joint section is formed at the transition between said second side limb section and said base limb section; and
said solid body joint is elastically deformable at least at said first and second joint sections.

15. The beverage container label cutting arrangement according to claim 14, wherein:
said solid body joint comprises an integral or one-piece structure;
the beverage container label cutting arrangement further comprises a stationary housing; and
said switching and adjusting device is secured to said housing via said first side limb section, which first side limb section is held in a fixed position on said housing.

16. The beverage container label cutting arrangement according to claim 15, wherein:
said switching and adjusting device comprises an essentially L-shaped switching lever element, which switching lever element comprises a first elongated portion and a second elongated portion smaller than said first elongated portion;
said switching and adjusting device comprises a switching device;
said second elongated portion is connected to said base limb section;
said first elongated portion is operatively connected to said switching device; and
said switching device is configured to be activated to pivotably move said switching lever element to thereby elastically deform said solid body joint at said first joint section and pivotably move said base limb section to move said second cutting element between said cutting position and said waiting position; and
the beverage container label cutting arrangement comprises a mechanical stop arrangement configured to restrict the range of adjusting movement of said first elongated portion to determine said cutting position and said waiting position of said second cutting element, which mechanical stop arrangement is adjustable to permit adjustment of said cutting position and said waiting position of said second cutting element.

17. The beverage container label cutting arrangement according to claim 16, wherein:
said switching and adjusting device comprises a cutting element holder configured to securely hold said second cutting element;
said switching and adjusting device comprises a locking structure configured and disposed to connect said cutting element holder to said switching lever element such that, upon pivoting movement of said base limb section about said first joint region, said second cutting element is pivoted with said switching element lever;
said switching and adjusting device comprises an adjustment device configured and disposed to move said cutting element holder relative to said switching lever element, and thereby pivot said second side limb section about said second joint section, to adjust said cutting distance;
said adjustment device comprises a threaded spindle comprising a differential thread;
said threaded spindle comprises, along its shaft, a first thread region and a second thread region, which both exhibit the same thread direction but with different thread pitches to one another;
said first thread region of the threaded spindle is accommodated in a counter-thread of said cutting element holder; and
said second thread region is accommodated in a counter-thread of said switching lever element.

18. The beverage container label cutting arrangement according to claim 10, wherein said first cutting element comprising, at least at said first cutting edge, a steel having a first hardness and being from the group of the cold-work steels, and said second cutting element comprising, at least at said second cutting edge, a carbide metal having a second hardness, wherein said second hardness being greater than said first hardness.

19. A method of using the beverage container label cutting arrangement configured to cut off an individual beverage container label from an unwound strip of beverage container label material according to claim 10, said method comprising the steps of:
cutting off an individual beverage container label from an unwound strip of beverage container label material upon a beverage container being moved into a labeling position adjacent said beverage container labeling device by rotating said drum and moving said first cutting edge past said second cutting edge and said first cutting edge and said second cutting edge interacting with one another; and
at least one of:
adjusting said first joint section and pivotably moving said second cutting element from the engaged, cutting position to the disengaged, waiting position to prevent cutting off of at least one other individual beverage container label; and
adjusting said second joint section, independently of said first joint section, and pivotably moving said second cutting element and adjusting the position of said second cutting element with respect to said switching and adjusting arrangement, and thereby adjusting the cutting distance between said first cutting element and said second cutting element.

20. The method of using the beverage container label cutting arrangement according to claim 19, wherein:
said switching and adjusting device comprises a solid body joint having a U-shaped profile, which solid body joint comprises said first joint section and said second joint section;
said solid body joint comprises a first side limb section, a second side limb section oriented essentially parallel to said first side limb section, and a base limb section disposed to connect said first side limb section and said second side limb section to form said U-shaped profile;
said first joint section is formed at the transition between said first side limb section and said base limb section;
said second joint section is formed at the transition between said second side limb section and said base limb section; and
said solid body joint is elastically deformable at least at said first and second joint sections.
